(19) United States
(12) Patent Application Publication
(10) Pub. No.: US 2026/0289213 A1
(43) Pub. Date: Sep. 24, 2026

(54) Terminal Device, Information Processing System, Information Processing Method, and Program

(71) Applicant: Seiko Instruments Inc., Chiba-shi (JP)

(72) Inventors: Aki ZUKERAN, Chiba-shi (JP); Yoshikazu KOMURO, Chiba-shi (JP)

(21) Appl. No.: 19/569,207

(22) Filed: Mar. 17, 2026

(30) Foreign Application Priority Data
Mar. 18, 2025 (JP) 2025-044050

(51) Int. Cl. G06K 19/06

(52) U.S. Cl. CPC G06K 19/06037

(57) ABSTRACT

A terminal device includes a conversion unit configured to create a file from information of a label, and convert the file into a two-dimensional code; and a display control unit configured to cause a display unit to display the two-dimensional code created by the conversion unit. The terminal device edits an image of a label as well as create the printing command based on the edited label, and enables the printer to print the edited label. A file can easily be shared between terminal devices such as mobile terminals in an environment without network connection. A file can easily be shared even between different platforms because a party that provides a file displays a two-dimensional code representing the file and a party that receives provision of the file can acquire the file by reading the displayed two-dimensional code. In addition, the file can be shared without using personal information.

### RELATED APPLICATIONS

This application claims priority to Japanese Patent application No. JP2025-044050, filed on March 18, 2025, the entire content of which is incorporated herein by reference.

### BACKGROUND OF THE INVENTION

### 1. Field of the Invention

The present invention relates to a terminal device, an information processing system, an information processing method, and a program.

### 2. Description of the Related Art

In recent years, a technology for keeping a print-use file in cloud storage and using the print-use file on a mobile terminal or the like to print with a printer has been in use (see Japanese Patent Application Laid-open No. 2020-140439).

There has also been known a usage of an application for printing a label in which one piece of print-use data is used by a plurality of pieces of external equipment with label printing applications installed therein. The print-use data is created by a label creating application located in a server, and each of the label creating applications downloads the print-use data from the server to use the data.

According to the technologies described above, in order for the pieces of external equipment to share the same print-use data in an environment without connection to the server, a different file sharing measure may be required.

An object of the present invention is to enable a plurality of applications to share various types of data.

### SUMMARY OF THE INVENTION

In one aspect, a terminal device includes a conversion unit configured to create a file from information of a label, and convert the file into a two-dimensional code; and a display control unit configured to cause a display unit to display the two-dimensional code created by the conversion unit.

In some embodiments, the terminal device includes a creation unit is provided to create an image of a label in which an object is placed. In other embodiments, the conversion unit is provided to create, based on a capacity of the file, a plurality of two-dimensional codes from the file, and the display control unit is provided to cause the display unit to display the plurality of two-dimensional codes created by the conversion unit. In certain embodiments, the terminal device includes a reading control unit configured to acquire the two-dimensional code by performing control for reading a two-dimensional code displayed on a display unit of another terminal device which is other than the terminal device, and the conversion unit is provided to convert the two-dimensional code that is displayed on the display unit of the another terminal device and that is acquired by the display control unit into a file. In preferred examples, the reading control unit is provided to acquire a plurality of two-dimensional codes displayed on the display unit of the another terminal device, and the conversion unit is provided to convert each of the plurality of two-dimensional codes acquired by the display control unit into a file. In other embodiments, the terminal device includes a creation unit configured to create a printing command based on the file.

In one aspect, a terminal device includes a reading control unit is provided to perform control for reading a two-dimensional code that is displayed on a display unit of another terminal device, to acquire the two-dimensional code; and a conversion unit is provided to convert the two-dimensional code acquired by the display control unit into a file.

In some embodiments, the reading control unit is provided to acquire a plurality of two-dimensional codes each of which is the two-dimensional code, and the conversion unit is provided to convert each of the plurality of two-dimensional codes acquired by the display control unit into an encoded file. In other embodiments, the terminal device includes a creation unit configured to create a printing command based on the file.

In one aspect, an information processing system includes a first terminal device and a second terminal device, the first terminal device includes a first conversion unit is provided to create a file from information of a label, and convert the file into a two-dimensional code; and a first display control unit is provided to cause a display unit to display the two-dimensional code created by the first conversion unit, and the second terminal device includes a second reading control unit is provided to perform control for reading the two-dimensional code that is displayed on the display unit of the first terminal device, to acquire the two-dimensional code; and a second conversion unit is provided to convert the two-dimensional code acquired by the second display control unit into a file.

In one aspect, an information processing method to be executed by a first terminal device and a second terminal device executes by the first terminal device for creating a file from information of a label, and creating a two-dimensional code from the file; and for causing a display unit to display the two-dimensional code; and executes by the second terminal device for performing control for reading the two-dimensional code that is displayed on the display unit of the first terminal device, to acquire the two-dimensional code; and for converting the two-dimensional code into a file.

In one aspect, a program for causing a computer of a terminal device creates a file from information of a label, and converts the file into a two-dimensional code; and cause a display unit to display the two-dimensional code.

In one aspect, a program for causing a computer of a terminal device performs control for reading a two-dimensional code that is displayed on a display unit of another terminal device, to acquire the two-dimensional code; and converts the two-dimensional code into a file.

The terminal device edits an image of a label as well as create the printing command based on the edited label, and enables the printer to print the edited label. A file can easily be shared between terminal devices such as mobile terminals in an environment without network connection. A file can easily be shared even between different platforms because a party that provides a file displays a two-dimensional code representing the file and a party that receives provision of the file can acquire the file by reading the displayed two-dimensional code. In addition, the file can be shared without using personal information.

### BRIEF DESCRIPTION OF THE DRAWINGS

FIG. 1 is a diagram for illustrating an example of a function configuration of an information processing system (1) according to at least one embodiment of the present invention.

FIG. 2 is a diagram for illustrating an example of a function configuration of a terminal device (20) and a terminal device (30) according to the at least one embodiment.

FIG. 3 is a diagram for illustrating an example of structure of a file.

FIG. 4 is a diagram for illustrating an example of information included in file data.

FIG. 5 is a flowchart for illustrating an example of a flow of processing between the terminal devices according to the at least one embodiment.

FIG. 6A is a display example of a display unit (250) of the terminal device (20) according to the at least one embodiment.

FIG. 6B is another display example of the display unit (250) of the terminal device (20) according to the at least one embodiment.

FIG. 7 is a diagram for illustrating an example of a function configuration of a terminal device (40) and a terminal device (50) according to a modification example of the at least one embodiment.

FIG. 8 is a diagram for illustrating an example of structure of a file.

FIG. 9 is a flowchart for illustrating an example of a flow of processing of the terminal device (40) according to the modification example of the at least one embodiment.

FIG. 10 is a flowchart for illustrating an example of a flow of processing of the terminal device (50) according to the modification example of the at least one embodiment.

FIG. 11A is a display example of the display unit (350) of the terminal device (50) according to the modification example of the at least one embodiment.

FIG. 11B is another display example of the display unit (350) of the terminal device (50) according to the modification example of the at least one embodiment.

### DETAILED DESCRIPTION OF THE PREFERRED EMBODIMENTS

Description is given on a terminal device, an information processing system, an information processing method, and a program according to at least one embodiment of the present invention with reference to the drawings. The at least one embodiment described below is merely an example, and embodiments to which the present invention is applied are not limited to the at least one embodiment described below.

Throughout the drawings for illustrating the at least one embodiment, components having the same function are denoted by the same reference symbols, and a duplicate description thereof is omitted.

The description "based on XX" as used herein means "based on at least XX," and encompasses a case of being "based on another element in addition to XX." Further, the description "based on XX" is not limited to a case of directly using "XX" but encompasses a case of being "based on a result of calculating or processing XX." The term "XX" refers to a freely selected element (for example, freely selected information).

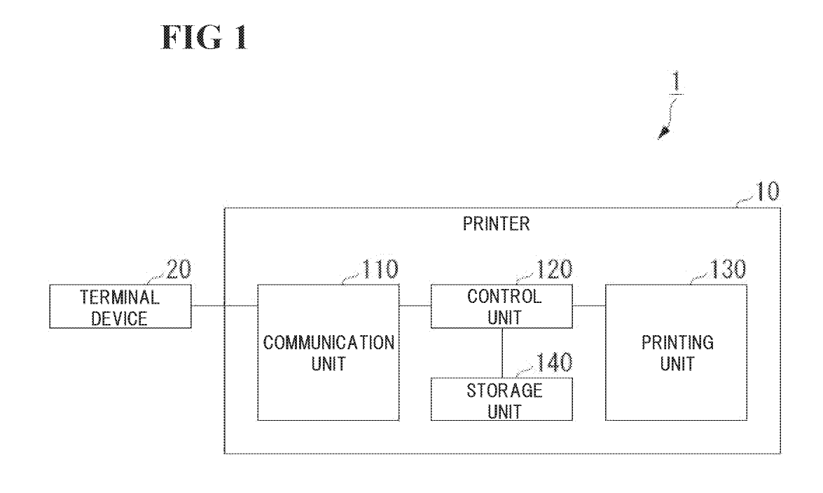

FIG. 1 is a diagram for illustrating an example of a function configuration of an information processing system 1 according to the at least one embodiment. The information processing system 1 includes a printer 10 and a terminal device 20.

The printer 10 includes a communication unit 110, a control unit 120, a printing unit 130, and a storage unit 140.

The communication unit 110 holds information communication to and from the terminal device 20, by a cable or radio, based on control of the control unit 120. The communication unit 110 receives a printing command transmitted by the terminal device 20.

The control unit 120 has a calculation function that is typically a calculation function of a CPU or the like, and provides various functions based on programs and data that are stored in the storage unit 140. The control unit 120 acquires the printing command from the communication unit 110 and, based on the acquired printing command, performs control for causing the printing unit 130 to print. For example, the control unit 120 outputs a control signal for causing the printing unit 130 to print.

The printing unit 130 includes a printing mechanism (not shown) which prints based on control of the control unit 120. The printing unit 130 is, for example, a dot line thermal printer. The printing unit 130 prints, for example, a label by processing the control signal output from the control unit 120.

The storage unit 140 includes a semiconductor memory and a hard disk device, and stores programs and data to be used by the control unit 120.

The terminal device 20 displays a label on a display unit, and edits the label based on operation of a user U. The terminal device 20 displays an image such as a preview image of the label based on operation of the user U. The terminal device 20 encodes the image of the label into a file based on operation of the user U, and creates, based on the file, the printing command for causing the printer 10 to print.

The terminal device 20 transmits the created printing command to the printer 10. This causes the printer 10 to execute printing. A program and data for interpreting the command are stored in the storage unit 140 of the printer 10 in advance. The communication unit 110 receives the printing command transmitted by the terminal device 20. The control unit 120 acquires the printing command from the communication unit 110, and interprets the acquired printing command based on the program and the data that are stored in the storage unit 140, to control the printing unit 130.

In the at least one embodiment, the information processing system 1 includes a terminal device 30 in addition to the terminal device 20. The terminal device 20 acquires an image of a label from the terminal device 30 without connecting to the terminal device 30. The term "connect" includes to connect by a cable and to connect by radio.

Specifically, the terminal device 20 reads a two-dimensional code such as a two-dimensional barcode, a Quick Response (QR) code (trademark), DataMatrix (DataCode), or MaxiCode that is displayed on the terminal device 30 to acquire the two-dimensional code. The subsequent description is about a case of applying a two-dimensional barcode as an example of the two-dimensional code. Two-dimensional codes other than a two-dimensional barcode are also applicable in the same manner as in the case of a two-dimensional barcode.

The terminal device 20 converts the acquired two-dimensional barcode into a file, and saves the file as a file of print-use data. The terminal device 20 creates the image of the label by decoding the file, and displays the created image of the label on the display unit. The terminal device 20 also creates the printing command based on the file, and transmits the printing command to the printer 10.

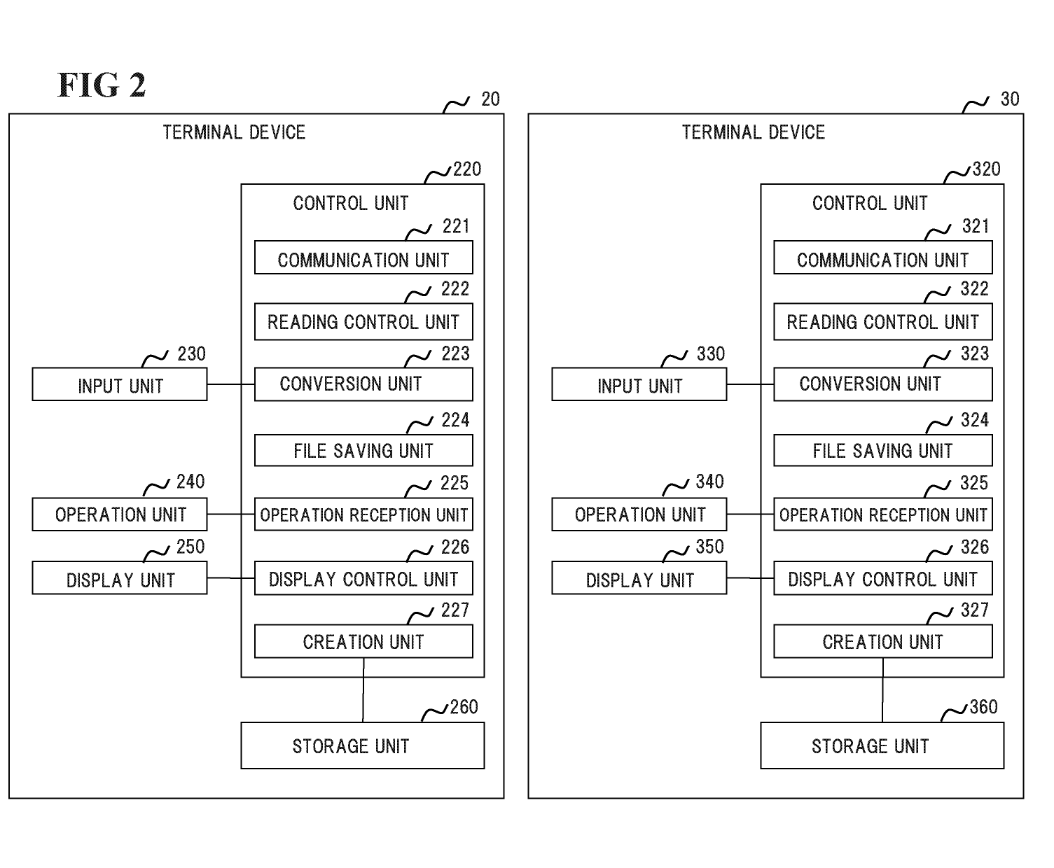

The terminal device 20 and the terminal device 30 are described in detail below. FIG. 2 is a diagram for illustrating an example of a function configuration of the terminal device 20 and the terminal device 30 according to the at least one embodiment.

### Terminal Device 20

The terminal device 20 is implemented by such a device as a personal computer, a server, a smartphone, a tablet computer, or an industrial computer. The terminal device 20 includes a control unit 220, an input unit 230, an operation unit 240, a display unit 250, and a storage unit 260.

The control unit 220 is a function unit (hereinafter referred to as "software function unit") implemented by a processor such as a central processing unit (CPU) by executing a program that is stored in the storage unit 260.

The control unit 220 may be implemented by hardware such as a large-scale integration (LSI) circuit, an application-specific integrated circuit (ASIC), or a field-programmable gate array (FPGA), or may be implemented by a combination of a software function unit and hardware.

The input unit 230 includes an image pickup device such as a camera, and reads a two-dimensional barcode such as a Quick Response (QR) code (trademark) based on control of the control unit 220.

The operation unit 240 is operation equipment, for example, a touch panel, a keyboard, or a mouse, and is operated by the user U.

The display unit 250 is display equipment, for example, a liquid crystal display, and displays various images based on control of the control unit 220.

The storage unit 260 includes, for example, a hard disk drive and a semiconductor memory (a flash memory, a RAM, or a ROM), and stores various types of information such as programs and data read out by the control unit 220. The storage unit 260 may be implemented by a virtual storage device such as a cloud server located outside the terminal device 20.

The control unit 220 includes, as function units thereof, a communication unit 221, a reading control unit 222, a conversion unit 223, a file saving unit 224, an operation reception unit 225, a display control unit 226, and a creation unit 227.

The communication unit 221 holds information communication to and from the printer 10 via NETWORK. As NETWORK, a network that suits a situation may be used, and examples of the network include the Internet, a cellular network, a Wi-Fi network, a low-power wide-area network (LPWAN), a wide area network (WAN), and a local area network (LAN), as well as other public circuits and dedicated circuits.

The operation reception unit 225 receives operation performed on the operation unit 240.

The display control unit 226 controls the display unit 250 so that various images are displayed.

The reading control unit 222 acquires information that indicates operation received by the operation reception unit 225 and, based on the acquired information that indicates the operation, performs control for reading a two-dimensional barcode with use of the image pickup device included in the input unit 230. The reading control unit 222 acquires the two-dimensional barcode read by the image pickup device.

The conversion unit 223 acquires the two-dimensional barcode from the reading control unit 222, and converts the acquired two-dimensional barcode into a file. The file includes, for example, binary data.

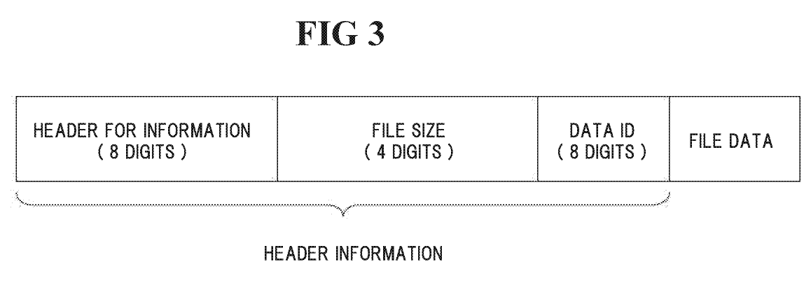

FIG. 3 is a diagram for illustrating an example of structure of the file. The file includes header information and file data. An example of the header information includes a header for identification (eight digits), a file size (four digits), and a data ID (eight digits).

The header for identification includes information for identifying the file. Whether the file has been obtained by encoding a label is identified, for example, from the header for identification. The file size includes information that indicates a size (capacity) of data included in the file data. The data ID includes identification information of the data.

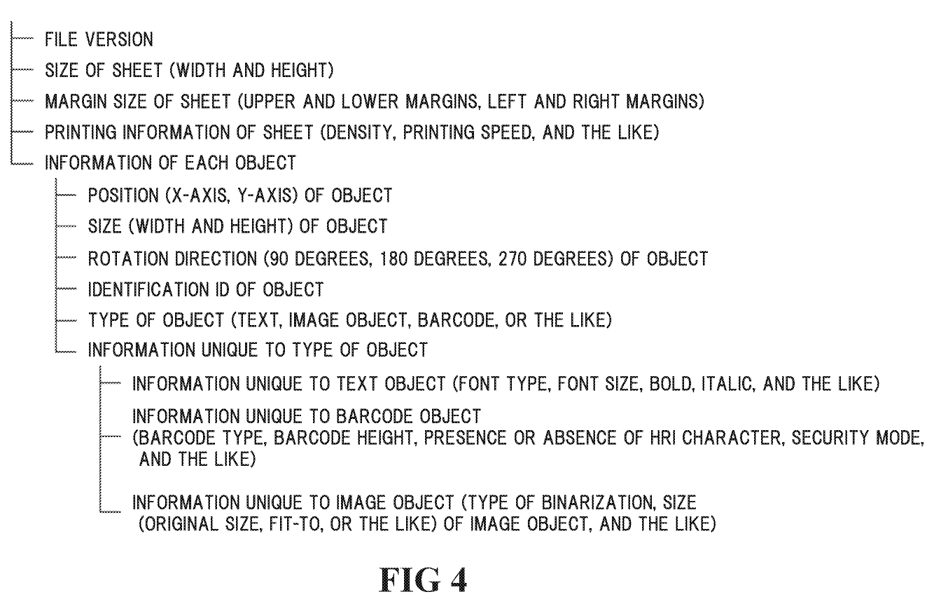

FIG. 4 is a diagram for illustrating an example of information included in the file data. As illustrated in FIG. 4, the file includes the following information.
1. A file version and a size of a sheet
2. A margin size of the sheet
3. Printing information of the sheet
4. Information of each object

The size of the sheet may be expressed in width and height. The margin size of the sheet may be expressed as sizes of upper and lower margins and left and right margins. The printing information of the sheet may include a density of printing, a printing speed, and the like.

Further, the information of each object includes the following information.

4-1. A position of the object

4-2. A size of the object

4-3. A rotation direction of the object

4-4. An identification ID of the object

4-5. The type of the object

4-6. Information unique to the type of the object

The position of the object may be expressed with use of an X-axis and a Y-axis. The size of the object may be expressed in width and height. The rotation direction of the object may be expressed as, for example, an angle from a reference determined in advance, such as 90 degrees, 180 degrees, and 270 degrees. Types of objects may include text, image object, barcode, and the like.

Further, the information unique to the type of the object includes the following information.

4-6-1. Information unique to text objects

4-6-2. Information unique to barcode objects

4-6-3. Information unique to image objects

The information unique to text objects includes a font type, a font size, bold, Italic, and the like. The information unique to barcode objects includes a barcode type, a barcode height, presence or absence of a Human Readable Interpretation (HRI) character, a security mode, and the like. The information unique to image objects includes the type of binarization, a size ("original size," "fit-to," or the like) of the image object, and the like. Referring back to FIG. 2, the description is continued.

The file saving unit 224 acquires the file from the conversion unit 223, and causes the storage unit 260 to store the acquired file as the print-use file.

The creation unit 227 acquires, from files stored in the storage unit 260, a file selected by the user U, and creates the printing command based on the acquired file. The creation unit 227 transmits the created printing command from the communication unit 221 to the printer 10.

### Terminal Device 30

The terminal device 30 is implemented by such a device as a personal computer, a server, a smartphone, a tablet computer, or an industrial computer. The terminal device 30 includes a control unit 320, an input unit 330, an operation unit 340, a display unit 350, and a storage unit 360.

The control unit 320 is a function unit (hereinafter referred to as "software function unit") implemented by a processor such as a central processing unit by executing a program that is stored in the storage unit 360.

The control unit 320 may be implemented by hardware such as an LSI circuit, an ASIC, or an FPGA, or may be implemented by a combination of a software function unit and hardware.

The input unit 330 includes an image pickup device such as a camera, and reads a two-dimensional barcode based on control of the control unit 320.

The operation unit 340 is operation equipment, for example, a touch panel, a keyboard, or a mouse, and is operated by the user U.

The display unit 350 is display equipment, for example, a liquid crystal display, and displays various images based on control of the control unit 320.

The storage unit 360 includes, for example, a hard disk drive and a semiconductor memory (a flash memory, a RAM, or a ROM), and stores various types of information such as programs and data read out by the control unit 320. The storage unit 360 may be implemented by a virtual storage device such as a cloud server located outside the terminal device 30.

The control unit 320 includes, as function units thereof, a communication unit 321, a reading control unit 322, a conversion unit 323, a file saving unit 324, an operation reception unit 325, a display control unit 326, and a creation unit 327.

The communication unit 321 holds information communication to and from the printer 10 via NETWORK.

The operation reception unit 325 receives operation performed on the operation unit 340.

The display control unit 326 controls the display unit 350 so that various images are displayed.

The reading control unit 322 acquires information that indicates operation received by the operation reception unit 325 and, based on the acquired information that indicates the operation, performs control for reading a two-dimensional barcode with use of the image pickup device included in the input unit 330. The reading control unit 322 acquires the two-dimensional barcode read by the image pickup device.

The creation unit 327 acquires information that indicates operation received by the operation reception unit 325, and creates an image of a label based on the acquired information that indicates the operation. The image of the label includes, for example, objects such as text, an image object, and a barcode.

The conversion unit 323 saves, as image information of the label, the information (the data illustrated in FIG. 4) of the label that has been received by the operation reception unit 325, and creates a file from the image data of the label. Information included in the file is, as described with reference to FIG. 3, header information and file data. Information included in the file data is, as described with reference to FIG. 4, (1) a file version and a size of a sheet, (2) a margin size of the sheet, (3) printing information of the sheet, and (4) information of each object. Descriptions on details thereof are omitted here, because the details are described above.

The file saving unit 324 acquires the file from the conversion unit 323, and causes the storage unit 360 to store the acquired file as the print-use file.

The conversion unit 323 acquires, from files stored in the storage unit 360, a file selected by the user U, and converts the acquired file into a two-dimensional barcode.

The display control unit 326 acquires the two-dimensional barcode from the conversion unit 323, and causes the display unit 350 to display the acquired two-dimensional barcode.

### Processing between Terminal Device 20 and Terminal Device 30

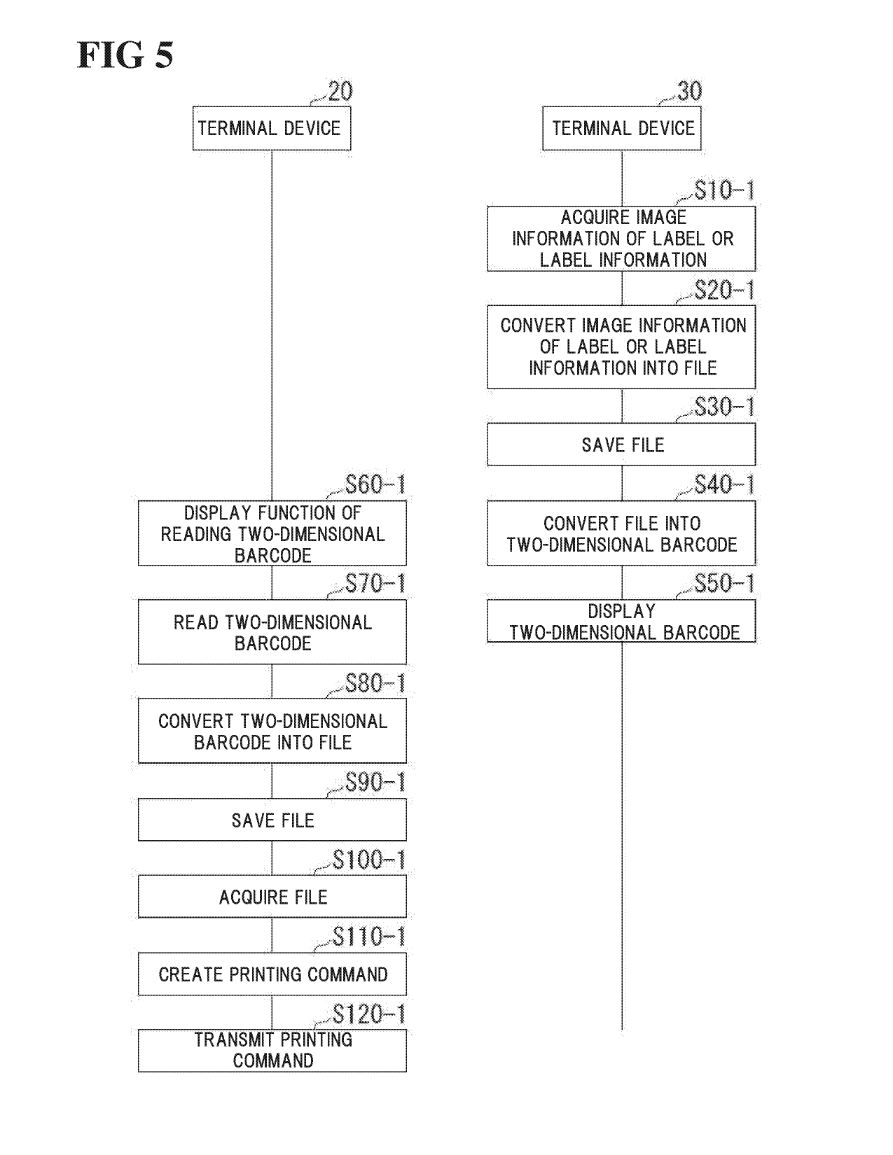

FIG. 5 is a flowchart for illustrating an example of a flow of processing between the terminal devices according to the at least one embodiment. Processing between the terminal device 20 and the terminal device 30 is described with reference to FIG. 5.

### Step S10-1

In the terminal device 30, the conversion unit 323 acquires image information of a label or label information. For example, the conversion unit 323 may acquire image information of a label or label information that has been created by the creation unit 327, or may acquire image information of a label or label information that has been created outside the terminal device 30 and received by the communication unit 321.

### Step S20-1

In the terminal device 30, the conversion unit 323 converts the acquired image information of a label or the acquired label information into a file by encoding the acquired information.

### Step S30-1

In the terminal device 30, the file saving unit 324 acquires the file from the conversion unit 323, and causes the storage unit 360 to store the acquired file.

### Step S40-1

In the terminal device 30, the conversion unit 323 acquires, from files stored in the storage unit 360, a file selected by the user U. The conversion unit 323 converts the acquired file into a two-dimensional barcode.

### Step S50-1

In the terminal device 30, the display control unit 326 acquires the two-dimensional barcode from the conversion unit 323, and causes the display unit 350 to display the acquired two-dimensional barcode.

### Step S60-1

In the terminal device 20, the display control unit 226 causes the display unit 250 to display a function of reading a two-dimensional barcode.

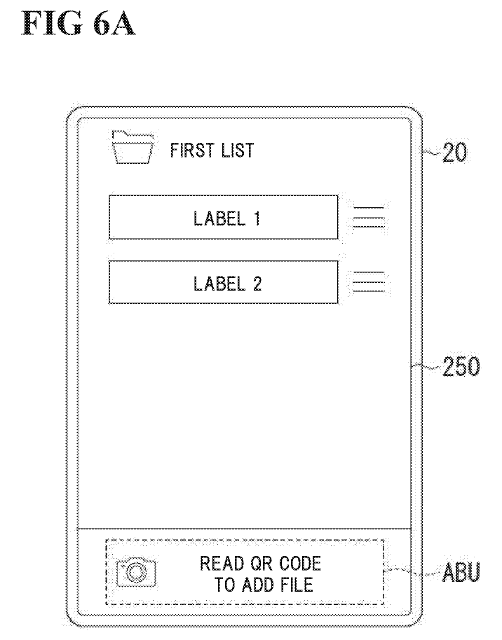

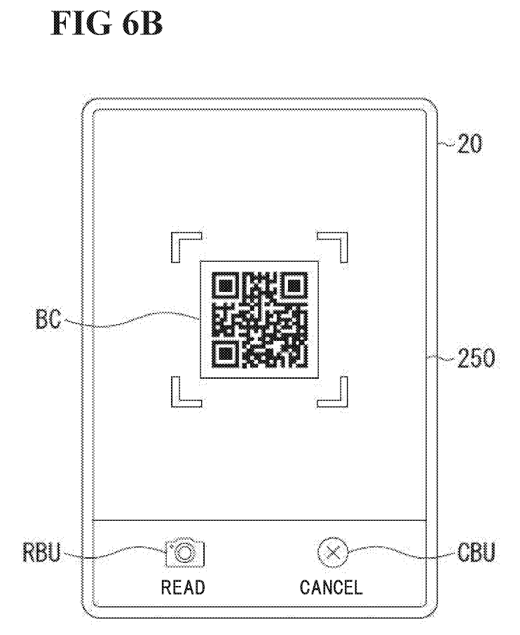

FIGS. 6A and 6B are display examples of the display unit 250 of the terminal device 20 according to the at least one embodiment. As illustrated in FIG. 6A, the display unit 250 displays a list of currently acquired files. In the example illustrated in FIG. 6A, the display unit 250 of the terminal device 20 displays that "Label 1" and "Label 2" have been acquired. The display unit 250 further displays an add button ABU to be pressed when a file is to be added by reading a two-dimensional barcode such as a QR code. The subsequent description is about a case in which operation performed by the user U is press of the add button ABU.

As illustrated in FIG. 6B, the display unit 250 displays a two-dimensional barcode BC read by the image pickup device that is included in the input unit 230. The display unit 250 further displays a read button RBU to be pressed in a case of reading the two-dimensional barcode BC, and a cancel button CBU to be pressed in a case of canceling the reading. Referring back to FIG. 5, the description is continued by describing a case in which the user U has pressed the read button RBU.

### Step S70-1

In the terminal device 20, the reading control unit 222 acquires information that indicates operation received by the operation reception unit 225 (the operation of pressing the read button RBU) and, based on the acquired information that indicates the operation, performs control for reading the two-dimensional barcode BC with the use of the image pickup device included in the input unit 230. The reading control unit 222 acquires the two-dimensional barcode BC read by the image pickup device.

### Step S80-1

In the terminal device 20, the conversion unit 223 acquires the two-dimensional barcode from the reading control unit 222, and converts the acquired two-dimensional barcode into a file.

### Step S90-1

In the terminal device 20, the file saving unit 224 acquires the file from the conversion unit 223, and causes the storage unit 260 to store the acquired file as a print-use file.

### Step S100-1

In the terminal device 20, the creation unit 227 acquires, from files that are stored in the storage unit 260 and that indicate labels, a file selected by the user U.

### Step S110-1

In the terminal device 20, the creation unit 227 creates the printing command based on the acquired file.

### Step S120-1

In the terminal device 20, the creation unit 227 transmits the created printing command from the communication unit 221 to the printer 10.

The printer 10 then receives the printing command transmitted by the terminal device 20, and executes printing based on the received printing command, to thereby print the label.

After Step S100-1 of the flow of processing between the terminal devices which is illustrated in FIG. 5, the following processing may be executed. The conversion unit 223 acquires information that indicates operation received by the operation reception unit 225 (operation of editing the image of the label), and acquires a file selected by the user U, based on the acquired information that indicates the operation, from the creation unit 227. The conversion unit 223 may create the image of the label by decoding the acquired file.

In this case, the display control unit 226 may acquire the image of the label from the conversion unit 223, and cause the display unit 250 to display the image of the label. The user U may operate the operation unit 240, and the operation reception unit 225 may receive the operation of the user U. The display control unit 226 may acquire information that indicates the operation received by the operation reception unit 225 and, based on the acquired information that indicates the operation, may edit the image of the label displayed on the display unit 250. The conversion unit 223 may then create a file by encoding the edited image of the label.

The creation unit 227 may acquire the file from the conversion unit 223, create the printing command based on the acquired file, and transmit the printing command from the communication unit 221 to the printer 10.

This configuration enables the terminal device 20 to edit an image of a label as well as create the printing command based on the edited label, and enables the printer 10 to print the edited label.

In the at least one embodiment described above, the terminal device 20 which has the function of reading a two-dimensional barcode among other functions and the terminal device 30 which has the function of displaying a two-dimensional barcode among other functions are described separately, but the present invention is not limited to this example. For example, the terminal device 20 may further have the functions of the terminal device 30 which include the function of displaying a two-dimensional barcode among other functions, or the terminal device 30 may further have the functions of the terminal device 20 which include the function of reading a two-dimensional barcode among other functions.

In the at least one embodiment described above, the case in which the terminal device 20 acquires an image of a label from the terminal device 30 has been described as an example. However, the present invention is not limited to this example. The terminal device 20 may acquire any information, not only a label, from the terminal device 30.

According to the at least one embodiment, a file can easily be shared between terminal devices such as mobile terminals in an environment without network connection.

Cases of providing the same application in an environment that includes different platforms such as Windows (trademark), Android (trademark), and iOS (trademark) are increasing, and file sharing between different platforms has hitherto involved such a hassle as using a cloud service. In addition, utilization of a file sharing service or external storage has required personal information in some cases.

According to the at least one embodiment, a file can easily be shared even between different platforms because a party that provides a file displays a two-dimensional barcode representing the file and a party that receives provision of the file can acquire the file by reading the displayed two-dimensional barcode. In addition, the file can be shared without using personal information.

### Modification Example of At Least One Embodiment

Two-dimensional barcodes include three types, for example, "Model 1," "Model 2," and "Micro QR" which differ from one another in data capacity.

A maximum data capacity of "Model 1" is 1,167 numeric characters, 707 alphanumeric characters, 468 bytes in binary, and 299 Chinese characters.

A maximum data capacity of "Model 2" is 7,089 numeric characters, 4,296 alphanumeric characters, 2,953 bytes in binary, and 1,817 Chinese characters.

A maximum data capacity of "Micro QR" is 35 numeric characters, 21 alphanumeric characters, 15 bytes in binary, and 9 Chinese characters.

In conversion of a label image into a two-dimensional barcode, a case in which the label image has too large a data capacity to be held in a single two-dimensional barcode is expected.

In view of the above, in a modification example of the at least one embodiment, when a file created from image information of a label is too large to be held in a single two-dimensional barcode, the image information of the label includes information indicating that there is a next two-dimensional barcode, and data sharing is enabled by reading the plurality of two-dimensional barcodes. The subsequent description takes a case of using "Model 2" as an example. The maximum data capacity of "Model 2" is 2,953 bytes in binary.

An information processing system 2 according to the modification example of the at least one embodiment is obtained by including a terminal device 40 in place of, or in addition to, the terminal device 20, and including a terminal device 50 in place of, or in addition to, the terminal device 30 in the information processing system 1.

The terminal device 40 acquires an image of a label from the terminal device 50 without connecting to the terminal device 50.

Specifically, the terminal device 40 sequentially reads a plurality of two-dimensional barcodes displayed on the terminal device 50, to thereby acquire the plurality of two-dimensional barcodes. The terminal device 40 converts each of the acquired plurality of two-dimensional barcodes into a file (hereinafter also referred to as "sub-file"), consolidates the plurality of sub-files to restore the file, and saves the restored file as a file of print-use data. The terminal device 40 creates the image of the label by decoding the file, and displays the created image of the label.

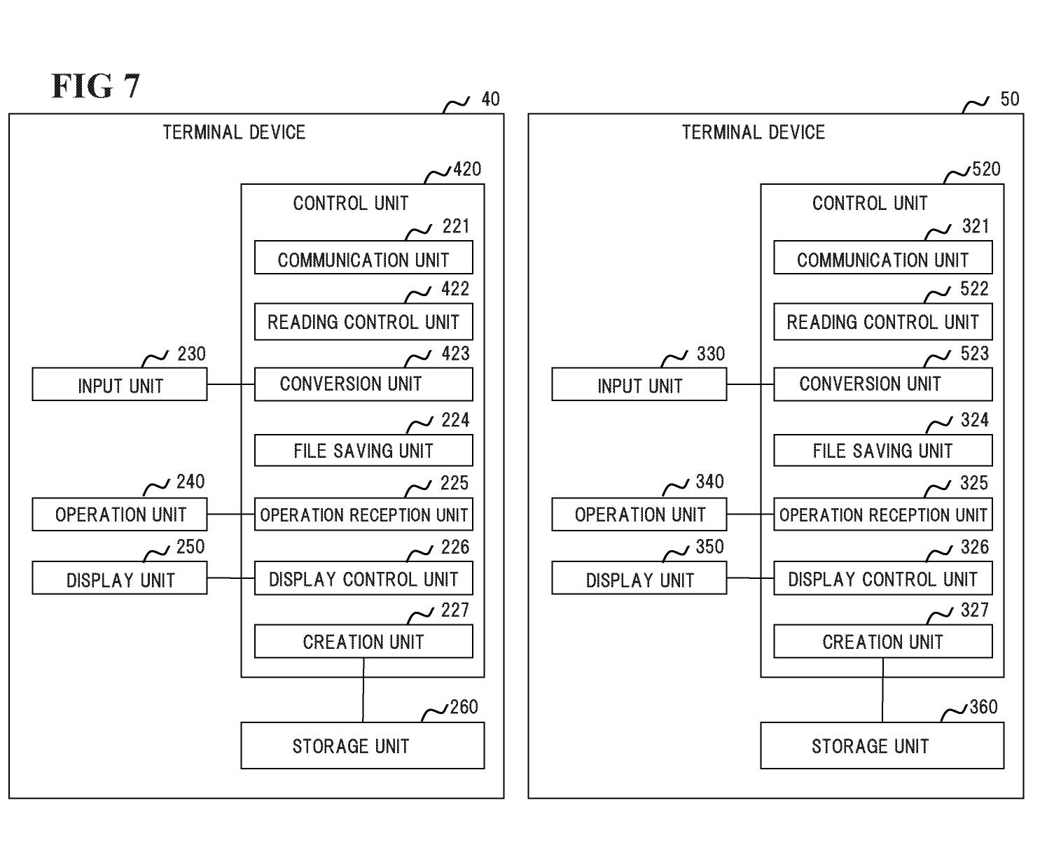

The terminal device 40 and the terminal device 50 are described in detail below. FIG. 7 is a diagram for illustrating an example of a function configuration of the terminal device 40 and the terminal device 50 according to the at least one embodiment.

### Terminal Device 40

The terminal device 40 is implemented by such a device as a personal computer, a server, a smartphone, a tablet computer, or an industrial computer. The terminal device 40 includes a control unit 420, an input unit 230, an operation unit 240, a display unit 250, and a storage unit 260.

The control unit 420 is a function unit (hereinafter referred to as "software function unit") implemented by a processor such as a central processing unit by executing a program that is stored in the storage unit 260.

The control unit 420 may be implemented by hardware such as an LSI circuit, an ASIC, or an FPGA, or may be implemented by a combination of a software function unit and hardware.

The control unit 420 includes, as function units thereof, a communication unit 221, a reading control unit 422, a conversion unit 423, a file saving unit 224, an operation reception unit 225, a display control unit 226, and a creation unit 227.

The reading control unit 422 acquires information that indicates operation received by the operation reception unit 225 and, based on the acquired information that indicates the operation, performs control for sequentially reading a plurality of two-dimensional barcodes with use of the image pickup device included in the input unit 230. The reading control unit 422 acquires each of the plurality of two-dimensional barcodes based on the plurality of two-dimensional barcodes sequentially read by the image pickup device.

The reading control unit 422 further performs, when notified by the conversion unit 423 that there is continuation data, control for sequentially reading a plurality of two-dimensional barcodes with the use of the image pickup device included in the input unit 230.

The conversion unit 423 acquires the plurality of two-dimensional barcodes from the reading control unit 422, and encodes each of the acquired plurality of two-dimensional barcodes to convert the two-dimensional barcode into a sub-file.

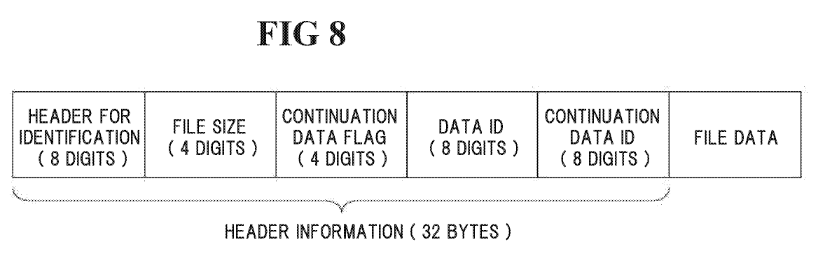

FIG. 8 is a diagram for illustrating an example of structure of a file. Here, structure of a sub-file is illustrated as an example of the structure of a file. The sub-file includes header information (32 bytes) and file data. An example of the header information includes a header for identification (eight digits), a file size (four digits), a continuation data flag (four digits), a data ID (eight digits), and a continuation data ID (eight digits).

The header for identification includes information for identifying the file. The file size includes information that indicates a size (capacity) of data included in the file data. The continuation data flag includes information that indicates whether there is data that is a continuation. The data ID includes identification information of the data. The continuation data ID includes a data ID of the data that is a continuation. Information included in the file data is, as described with reference to FIG. 4, (1) a file version and a size of a sheet, (2) a margin size of the sheet, (3) printing information of the sheet, and (4) information of each object. Descriptions on details thereof are omitted here, because the details are described above. Referring back to FIG. 7, the description is continued.

The conversion unit 423 converts each of the acquired two-dimensional barcodes into a file (sub-file). The conversion unit 423 determines whether the continuation data flag included in the header information of the file (sub-file) includes information that indicates existence of continuation data. When determining that the continuation data flag includes information that indicates existence of continuation data, the conversion unit 423 notifies the reading control unit 422 that there is continuation data.

The conversion unit 423 converts each of the acquired plurality of two-dimensional barcodes into a sub-file. The conversion unit 423 consolidates the plurality of sub-files, to thereby restore the file.

### Terminal Device 50

The terminal device 50 is implemented by such a device as a personal computer, a server, a smartphone, a tablet computer, or an industrial computer. The terminal device 50 includes a control unit 520, an input unit 330, an operation unit 340, a display unit 350, and a storage unit 360.

The control unit 520 is a function unit (hereinafter referred to as "software function unit") implemented by a processor such as a central processing unit by executing a program that is stored in the storage unit 360.

The control unit 520 may be implemented by hardware such as an LSI circuit, an ASIC, or an FPGA, or may be implemented by a combination of a software function unit and hardware.

The control unit 520 includes, as function units thereof, a communication unit 321, a reading control unit 522, a conversion unit 523, a file saving unit 324, an operation reception unit 325, a display control unit 326, and a creation unit 327.

The creation unit 327 acquires information that indicates operation received by the operation reception unit 325, and creates an image of a label based on the acquired information that indicates the operation.

The conversion unit 523 saves, as image information of the label, the information of the label that has been received by the operation reception unit 325, and creates a file from the image data of the label. Information included in the file is, as described with reference to FIG. 8, header information and file data. Information included in the file data is, as described with reference to FIG. 4, (1) a file version and a size of a sheet, (2) a margin size of the sheet, (3) printing information of the sheet, and (4) information of each object. Descriptions on details thereof are omitted here, because the details are described above.

The conversion unit 523 acquires, from files stored in the storage unit 360, a file selected by the user U, and converts the acquired file into a two-dimensional barcode. For example, the conversion unit 523 loads the file, and determines whether the capacity of the loaded file exceeds a data capacity that can be held in a single two-dimensional barcode.

When determining that the capacity of the loaded file exceeds the data capacity that can be held in a single two-dimensional barcode, the conversion unit 523 calculates the number of two-dimensional barcodes to be created. The conversion unit 523 converts the file into a plurality of two-dimensional codes based on the capacity of the file. In a case of creating a plurality of two-dimensional barcodes, the conversion unit 523 includes information indicating that there is continuation data in the continuation data flag, and includes information indicating the data ID of the data that is the continuation in the continuation data ID.

The display control unit 326 acquires the plurality of two-dimensional barcodes from the conversion unit 523, and causes the display unit 350 to display the acquired plurality of two-dimensional barcodes.

### Processing of Terminal Device 40

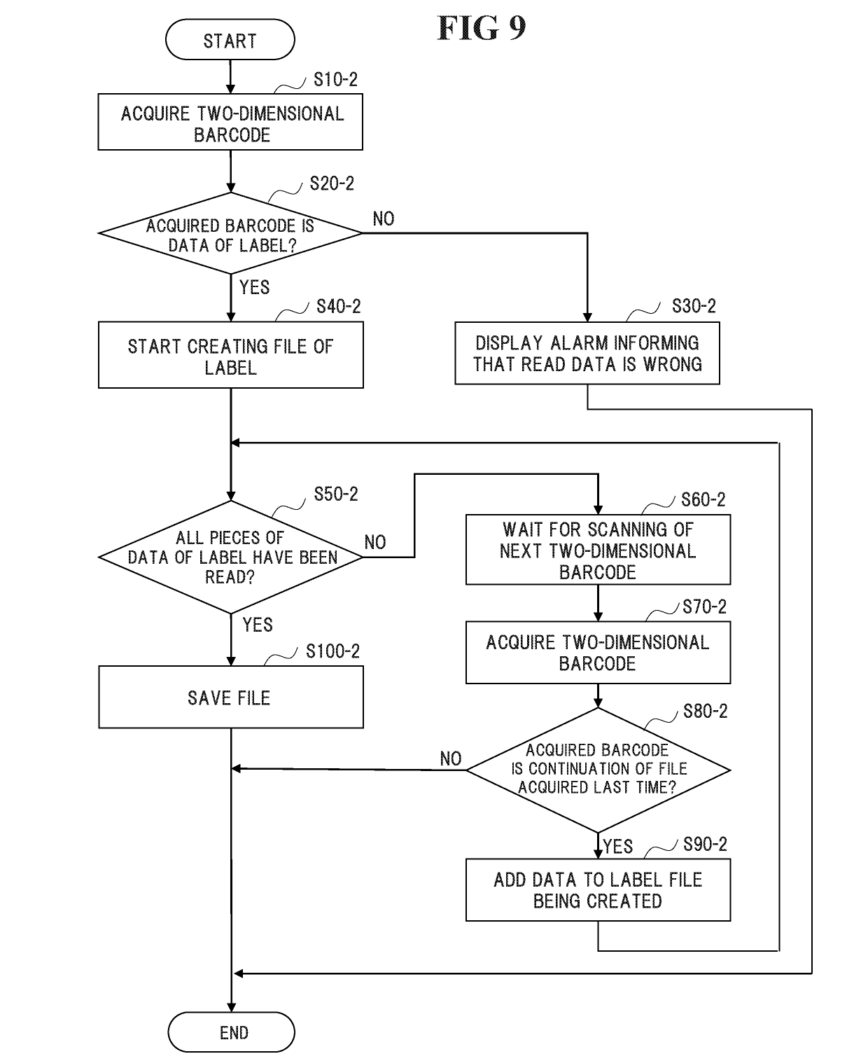

FIG. 9 is a flowchart for illustrating an example of a flow of processing of the terminal device 40 according to the modification example of the at least one embodiment. Processing executed by the terminal device 40 to read a plurality of two-dimensional barcodes, convert the read barcodes into a file, and save the file in the storage unit 260 is described with reference to FIG. 9.

### Step S10-2

In the terminal device 40, the conversion unit 423 acquires a two-dimensional barcode. In the terminal device 40, the display control unit 226 causes the display unit 250 to display the function of reading a two-dimensional barcode. FIGS. 6A and 6B are applicable as display examples of the display unit 250, and description thereof is accordingly omitted.

### Step S20-2

In the terminal device 40, the conversion unit 423 determines, based on the acquired two-dimensional barcode, whether the two-dimensional barcode represents data of a label. For example, the conversion unit 423 converts the two-dimensional barcode into a file, and refers to the header for identification included in the header information of the file to determine whether the file is data that has been obtained by encoding a label.

### Step S30-2

In the terminal device 40, when determining that data of the acquired two-dimensional barcode is not data of a label, the conversion unit 423 determines that the read two-dimensional barcode is wrong. In this case, the conversion unit 423 outputs a command to display alarm to the display control unit 226. The display control unit 226 causes the display unit 250 to display alarm, based on the command output from the conversion unit 423 to display alarm. The process is then ended.

### Step S40-2

In the terminal device 40, when determining that data of the acquired two-dimensional barcode is data of a label, the conversion unit 423 starts creating a file of the label. A file of a label is a file obtained by encoding an image of the label.

### Step S50-2

In the terminal device 40, the conversion unit 423 determines whether all pieces of data of the label have been read. For example, the conversion unit 423 converts the two-dimensional barcode into a file (sub-file), and refers to the continuation data ID included in the header information of the file (sub-file) to determine whether all pieces of data (two-dimensional barcodes) of the label have been read. For example, the conversion unit 423 may determine that all pieces of data (two-dimensional barcodes) of the label have been read when no data ID is included in the continuation data ID.

### Step S60-2

In the terminal device 40, when determining that not all pieces of data of the label have been read, the conversion unit 423 stands by for scanning (reading) of the next two-dimensional barcode.

### Step S70-2

In the terminal device 40, the conversion unit 423 acquires a two-dimensional barcode.

### Step S80-2

In the terminal device 40, the conversion unit 423 determines whether the acquired two-dimensional barcode is a continuation of the file (sub-file) acquired the last time. For example, the conversion unit 423 refers to the data ID included in the header information of the file (sub-file), and determines whether the referred-to data ID matches the data ID that is included in the continuation data ID included in the header information of the file (sub-file) acquired the last time.

For example, the conversion unit 423 may determine that the acquired two-dimensional barcode is a continuation of the file (sub-file) acquired the last time when the data ID included in the header information of the file (sub-file) matches the data ID that is included in the continuation data ID included in the header information of the file (sub-file) acquired the last time. When the acquired two-dimensional barcode is not a continuation of the file (sub-file) acquired the last time, the process is ended.

### Step S90-2

In the terminal device 40, when the acquired two-dimensional barcode is a continuation of the file (sub-file) acquired the last time, the conversion unit 423 adds the data to the file that is being created. The process then proceeds to Step S50-2.

### Step S100-2

In the terminal device 40, when determining that all pieces of data of the label have been read, the conversion unit 423 consolidates the plurality of sub-files, to thereby restore the file. The conversion unit 423 causes the restored file to be saved in the storage unit 260.

### Processing of Terminal Device 50

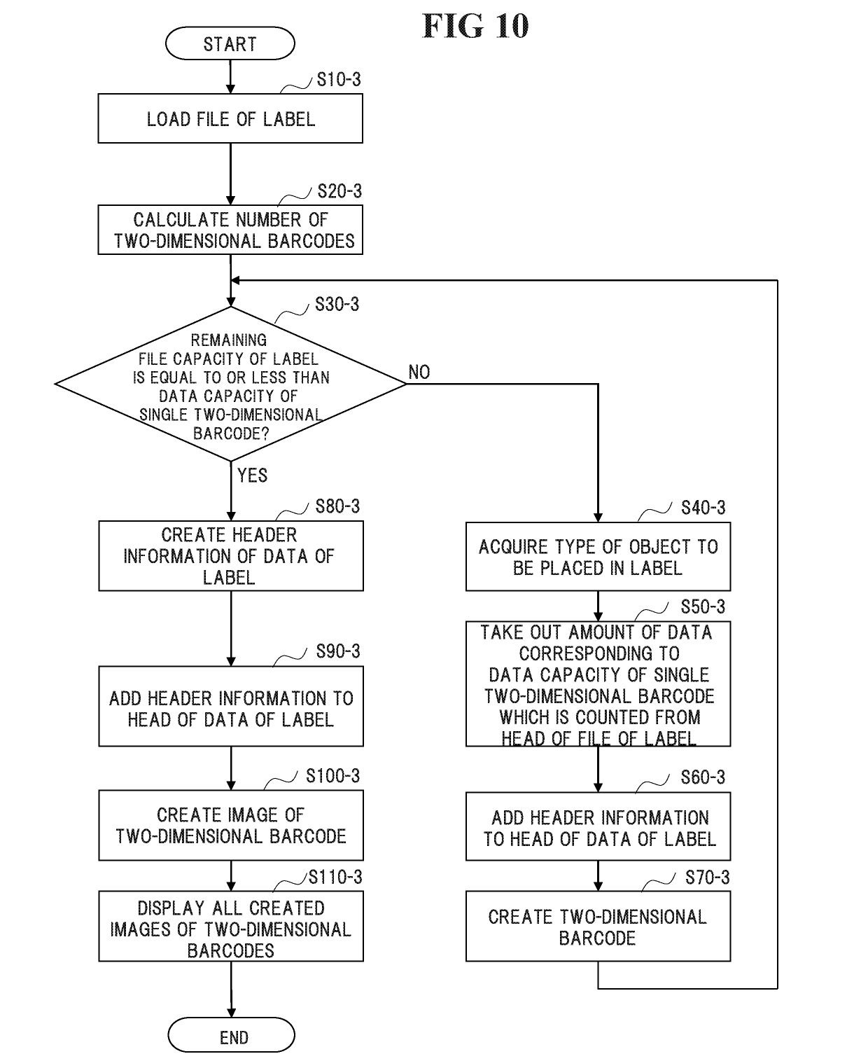

FIG. 10 is a flowchart for illustrating an example of a flow of processing of the terminal device 50 according to the modification example of the at least one embodiment. Processing executed by the terminal device 50 to display two-dimensional barcodes is described with reference to FIG. 10.

### Step S10-3

In the terminal device 50, the conversion unit 523 loads a file of a label.

### Step S20-3

In the terminal device 50, the conversion unit 523 determines whether the capacity of the loaded file exceeds a data capacity that can be held in a single two-dimensional barcode. When determining that the capacity of the loaded file exceeds the data capacity that can be held in a single two-dimensional barcode, the conversion unit 523 calculates the number of two-dimensional barcodes to be created. The subsequent description is about a case in which the capacity of the loaded file exceeds the data capacity that can be held in a single two-dimensional barcode.

### Step S30-3

In the terminal device 50, the conversion unit 523 determines whether a remaining capacity of the file of the label is equal to or less than the data capacity of a single two-dimensional barcode.

### Step S40-3

In the terminal device 50, when determining that the remaining capacity of the file of the label is not equal to or less than the data capacity of a single two-dimensional barcode, the conversion unit 523 acquires the type of an object to be placed in the label.

### Step S50-3

In the terminal device 50, the conversion unit 523 takes out an amount of data corresponding to the data capacity of a single two-dimensional barcode which is counted from a head of the file of the label.

### Step S60-3

In the terminal device 50, the conversion unit 523 adds (attaches) header information to a head of the data of the label.

### Step S70-3

In the terminal device 50, the conversion unit 523 creates a two-dimensional barcode. The process proceeds to Step S30-3.

### Step S80-3

In the terminal device 50, when determining that the remaining capacity of the file of the label is equal to or less than the data capacity of a single two-dimensional barcode, the conversion unit 523 creates header information of the data of the label.

### Step S90-3

In the terminal device 50, the conversion unit 523 adds (attaches) header information to a head of the data of the label.

### Step S100-3

In the terminal device 50, the conversion unit 523 creates an image of the two-dimensional barcode.

### Step S110-3

In the terminal device 50, the display control unit 326 causes the display unit 350 to display all images of two-dimensional barcodes that have been created.

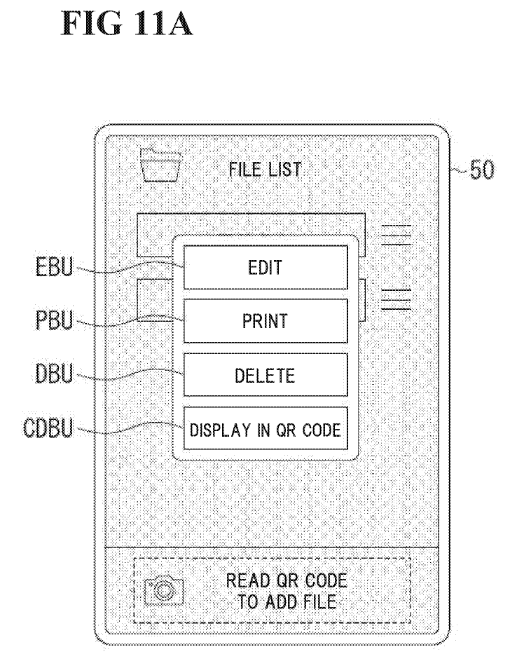

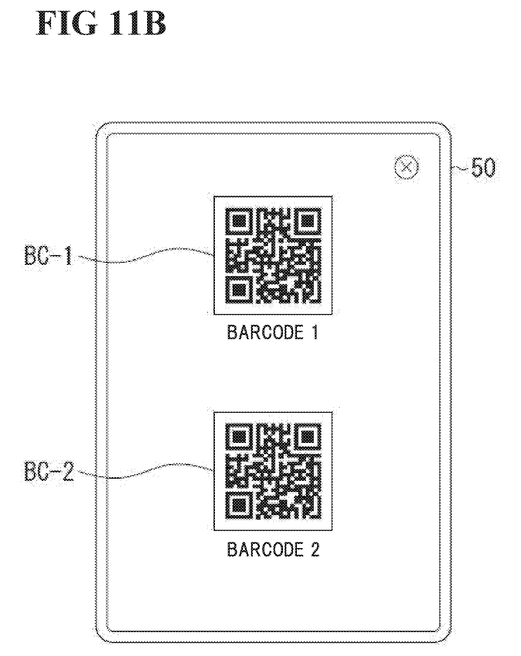

FIGS. 11A and 11B are display examples of the display unit 350 of the terminal device 50 according to the modification example of the at least one embodiment. As illustrated in FIG. 11A, the display unit 350 displays a list of options for operation performable on an image of a label. In the example illustrated in FIG. 11A, it can be seen that the terminal device 50 enables editing, printing, and deletion of an image of a label, and is also capable of displaying the image in the form of a two-dimensional barcode such as a QR code.

For example, an image of a label can be edited by pressing an edit button EBU, an image of a label can be printed by pressing a print button PBU, an image of a label can be deleted by pressing a delete button DBU, and an image of a label can be displayed in the form of a two-dimensional barcode by pressing a two-dimensional barcode display button CDBU. The subsequent description is about a case in which operation performed by the user U is press of the two-dimensional barcode display button CDBU.

As illustrated in FIG. 11B, a two-dimensional barcode BC-1 and a two-dimensional barcode BC-2 which are converted from a file created by coding an image of a label are displayed on the display unit 250.

The party that receives provision of the images of the label reads the two-dimensional barcode BC-1 and the two-dimensional barcode BC-2, converts the read barcodes into a file, and decodes the file with the terminal device 40, to thereby be able to acquire the image of the label.

In the modification example of the at least one embodiment, the case in which a plurality of two-dimensional barcodes are displayed at once on the terminal device 50 has been described as an example, but the present invention is not limited to this example.

For example, a plurality of two-dimensional barcodes may be displayed one barcode at a time on the terminal device 50. In this case, an OK button for displaying the next two-dimensional barcode may be displayed along with the displayed two-dimensional barcode. The next two-dimensional barcode is displayed by pressing the OK button. An advantage of this configuration compared to the case of displaying a plurality of two-dimensional barcodes is that reading a plurality of two-dimensional barcodes in a wrong order is preventable.

Alternatively, information indicating a place in order, for example, may be included in each of a plurality of two-dimensional barcodes displayed on the terminal device 50. With this configuration, even when a plurality of two-dimensional barcodes are read in a wrong order on the terminal device 40, the file can be restored based on the information that is included in each of the plurality of two-dimensional barcodes to indicate a place in order.

In the modification example of the at least one embodiment described above, the terminal device 40 which has the function of reading a two-dimensional barcode among other functions and the terminal device 50 which has the function of displaying a two-dimensional barcode among other functions have been described separately, but the present invention is not limited to this example. For example, the terminal device 40 may further have the functions of the terminal device 50 which include the function of displaying a two-dimensional barcode among other functions, or the terminal device 50 may further have the functions of the terminal device 40 which include the function of reading a two-dimensional barcode among other functions.

In the modification example of the at least one embodiment described above, the case in which the terminal device 40 acquires an image of a label from the terminal device 50 has been described as an example. However, the present invention is not limited to this example. The terminal device 40 may acquire any information, not only a label, from the terminal device 50.

The modification example of the at least one embodiment has, in addition to the same effects as those of the at least one embodiment, an effect of enabling easy file sharing even when a file to be shared between different platforms has a large capacity, because a party that provides a file displays a plurality of two-dimensional barcodes representing the file and a party that receives provision of the file can acquire the file by reading the displayed plurality of two-dimensional barcodes.

### Supplementary Notes

### Configuration Example 1

A terminal device includes: a conversion unit configured to create a file from information of a label, and convert the file into a two-dimensional code; and a display control unit configured to cause a display unit to display the two-dimensional code created by the conversion unit.

### Configuration Example 2

In the terminal device according to [Configuration Example 1], the terminal device further includes a creation unit configured to create an image of a label in which an object is placed.

### Configuration Example 3

In the terminal device according to [Configuration Example 1], the conversion unit is configured to create, based on a capacity of the file, a plurality of two-dimensional codes from the file, and the display control unit is configured to cause the display unit to display the plurality of two-dimensional codes created by the conversion unit.

### Configuration Example 4

In the terminal device according to [Configuration Example 1], the terminal device further includes the reading control unit configured to acquire the two-dimensional code by performing control for reading a two-dimensional code displayed on a display unit of another terminal device which is other than the terminal device, and the conversion unit is configured to convert the two-dimensional code acquired by the display control unit into a file.

### Configuration Example 5

In the terminal device according to [Configuration Example 4], the reading control unit is configured to acquire a plurality of two-dimensional codes, and the conversion unit is configured to convert each of the plurality of two-dimensional codes acquired by the display control unit into a file.

### Configuration Example 6

In the terminal device according to [Configuration Example 4] or [Configuration Example 5], the terminal device further includes a creation unit configured to create a printing command based on the file.

### Configuration Example 7

A terminal device includes: a reading control unit configured to perform control for reading a two-dimensional code that is displayed on a display unit of another terminal device, to acquire the two-dimensional code; and a conversion unit configured to convert the two-dimensional code acquired by the display control unit into a file.

### Configuration Example 8

In the terminal device according to [Configuration Example 7], the reading control unit is configured to acquire a plurality of two-dimensional codes each of which is the two-dimensional code, and the conversion unit is configured to convert each of the plurality of two-dimensional codes acquired by the display control unit into an encoded file.

### Configuration Example 9

In the terminal device according to [Configuration Example 7] or [Configuration Example 8], the terminal device further includes a creation unit configured to create a printing command based on the file.

### Configuration Example 10

An information processing system includes a first terminal device and a second terminal device. The first terminal device includes: a first conversion unit configured to create a file from information of a label, and convert the file into a two-dimensional code; and a first display control unit configured to cause a display unit to display the two-dimensional code created by the first conversion unit. The second terminal device includes: a second reading control unit configured to perform control for reading the two-dimensional code that is displayed on the display unit of the first terminal device, to acquire the two-dimensional code; and a second conversion unit configured to convert the two-dimensional code acquired by the second display control unit into a file.

In the above, the at least one embodiment of the present invention has been described in detail with reference to the accompanying drawings. However, specific configurations of the present invention are not limited to those of the at least one embodiment and encompass design modifications and the like without departing from the gist of the present invention.

For example, a computer program for implementing the functions of each of the above-mentioned devices may be recorded on a computer-readable recording medium, and the program recorded on the recording medium may be read into a computer system and executed. The term "computer system" as used herein may encompass OSs as well as peripheral equipment and other types of hardware.

The term "computer-readable recording medium" refers to a writable non-volatile memory such as a flexible disk, a magneto-optical disc, a ROM, and a flash memory, a portable medium such as a digital versatile disc (DVD), or a storage device such as a hard disk drive built in a computer system.

The term "computer-readable recording medium" also encompasses what holds a program for a given period of time, such as a volatile memory (such as a dynamic random access memory (DRAM)) inside a computer system that serves as a server or a client when a program is transmitted over the Internet or a similar network or via a telephone line or a similar communication line.

The program described above may be transmitted from a computer system in which the program is stored in a storage device or the like to another computer system via a transmission medium or on transmission waves in a transmission medium. The term "transmission medium" through which the program is transmitted as used herein refers to a medium having a function of transmitting information, such as the Internet or a similar network (a communication network), or a telephone line or a similar communication line (a communication wire).

The program described above may also be a program for implementing some of the functions described above. The program described above may also be what is called a differential file (a differential program), with which the functions described above can be implemented by being used in combination with a program already recorded in the computer system.

What is claimed is:

1. A terminal device, comprising:
a conversion unit configured to create a file from information of a label, and convert the file into a two-dimensional code; and
a display control unit configured to cause a display unit to display the two-dimensional code created by the conversion unit.

2. The terminal device according to claim 1, further comprising a creation unit configured to create an image of a label in which an object is placed.

3. The terminal device according to claim 1,
wherein the conversion unit is configured to create, based on a capacity of the file, a plurality of two-dimensional codes from the file, and
wherein the display control unit is configured to cause the display unit to display the plurality of two-dimensional codes created by the conversion unit.

4. The terminal device according to claim 1, further comprising a reading control unit configured to acquire the two-dimensional code by performing control for reading a two-dimensional code displayed on a display unit of another terminal device which is other than the terminal device, and
wherein the conversion unit is configured to convert the two-dimensional code that is displayed on the display unit of the another terminal device and that is acquired by the display control unit into a file.

5. The terminal device according to claim 4,
wherein the reading control unit is configured to acquire a plurality of two-dimensional codes displayed on the display unit of the another terminal device, and
wherein the conversion unit is configured to convert each of the plurality of two-dimensional codes acquired by the display control unit into a file.

6. The terminal device according to claim 4, further comprising a creation unit configured to create a printing command based on the file.

7. A terminal device, comprising:
a reading control unit configured to perform control for reading a two-dimensional code that is displayed on a display unit of another terminal device, to acquire the two-dimensional code; and
a conversion unit configured to convert the two-dimensional code acquired by the display control unit into a file.

8. The terminal device according to claim 7,
wherein the reading control unit is configured to acquire a plurality of two-dimensional codes each of which is the two-dimensional code, and
wherein the conversion unit is configured to convert each of the plurality of two-dimensional codes acquired by the display control unit into an encoded file.

9. The terminal device according to claim 7, further comprising a creation unit configured to create a printing command based on the file.

10. An information processing system, comprising a first terminal device and a second terminal device,
wherein the first terminal device includes:
a first conversion unit configured to create a file from information of a label, and convert the file into a two-dimensional code; and
a first display control unit configured to cause a display unit to display the two-dimensional code created by the first conversion unit, and
wherein the second terminal device includes:
a second reading control unit configured to perform control for reading the two-dimensional code that is displayed on the display unit of the first terminal device, to acquire the two-dimensional code; and
a second conversion unit configured to convert the two-dimensional code acquired by the second display control unit into a file.

11. An information processing method to be executed by a first terminal device and a second terminal device,
the information processing method comprising:
executing, by the first terminal device:
creating a file from information of a label, and creating a two-dimensional code from the file; and
causing a display unit to display the two-dimensional code; and
executing, by the second terminal device:
performing control for reading the two-dimensional code that is displayed on the display unit of the first terminal device, to acquire the two-dimensional code; and
converting the two-dimensional code into a file.

12. A non-transitory computer readable medium that stores a computer program implemented by a computer of a terminal device to:
create a file from information of a label, and convert the file into a two-dimensional code; and
cause a display unit to display the two-dimensional code.

13. A non-transitory computer readable medium that stores a computer program implemented by a computer of a terminal device to:
perform control for reading a two-dimensional code that is displayed on a display unit of another terminal device, to acquire the two-dimensional code; and
convert the two-dimensional code into a file.
